(19) United States
(12) Patent Application Publication
(10) Pub. No.: US 2014/0217114 A1
(43) Pub. Date: Aug. 7, 2014

(54) AUTOMATIC VENDING MACHINE WITH BUFFERING DEVICE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: ZHI-YONG GAO, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/037,613

(22) Filed: Sep. 26, 2013

(30) Foreign Application Priority Data
Feb. 5, 2013 (CN) 2013100444667

(51) Int. Cl. G07F 11/24

(52) U.S. Cl. CPC G07F 11/24
USPC 221/231

(57) ABSTRACT

An automatic vending machine includes a cabinet, a transporting device secured to the cabinet, a driving device, and a buffering device moveable received in the transporting device. The cabinet comprises a bottom panel and a first passageway located above the bottom panel. The bottom panel defines an opening. The buffering device is engaged with the driving device and comprises a hollow box. The hollow box comprises an entrance and an exit opposite to the entrance and located on the bottom panel. The entrance is aligned with the first passageway. The buffering device is moveable relative to the bottom panel by the driving device in a direction that is substantially parallel to the bottom panel, so that the hollow box is removed from the first passage to align with the opening, for the first product to move out of the bottom panel.

### BACKGROUND

1. Technical Field

The present disclosure relates to automatic vending machines, particularly to an automatic vending machine with a buffering device.

2. Description of Related Art

Automatic vending machines allow customers to buy products at any hours of the day. When the customer purchases the product from the automatic vending machine, a helical element in a cabinet is rotated to push the product out of the cabinet. However, a free end of the helical element may be warped or otherwise act to snag or catch on the product, preventing the delivery of the product out of the cabinet. In addition, the pressure between the product and the cabinet may be so high that the product may be destroyed. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an automatic vending machine in accordance with an embodiment.

FIG. 2 is an assembled view of the automatic vending machine of FIG. 1, and a buffering device is in a first position.

FIG. 3 is similar to FIG. 2, and the buffering device is in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

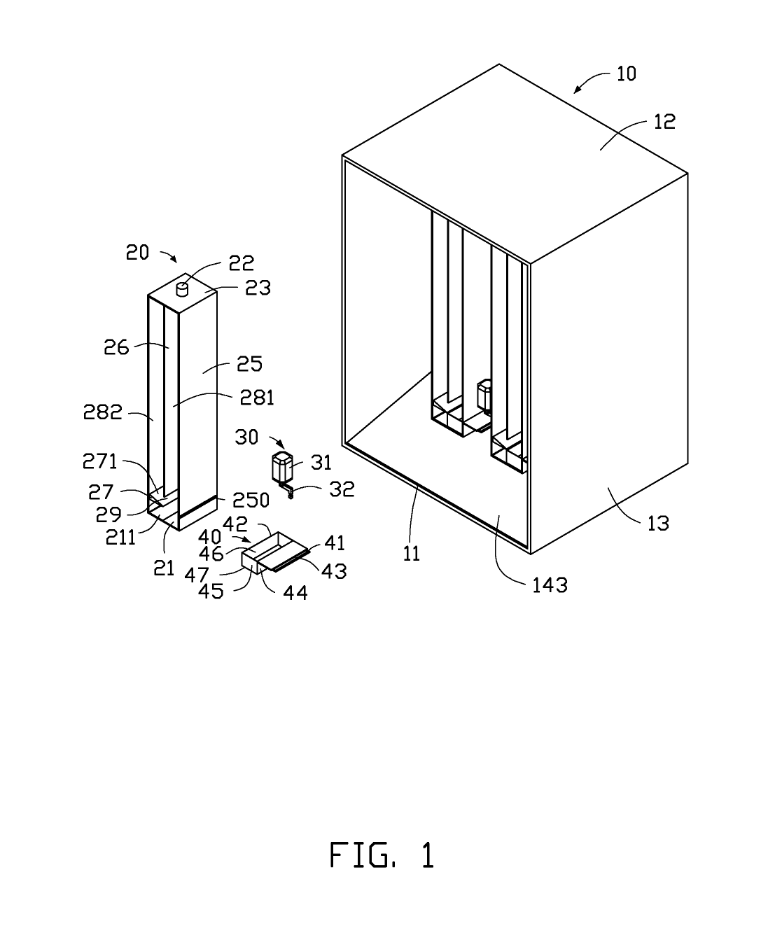

FIGS. 1 is an illustrated embodiment of an automatic vending machine. The automatic vending machine comprises a cabinet 10, a plurality of transporting devices 20 received in the cabinet 10, a plurality of driving devices 30, and a plurality of buffering devices 40. For example, each buffering device 40 may be a motor.

The cabinet 10 comprises a bottom plate 11, a top plate 12, and two side plates 13 connected to the bottom plate 11 and the top plate 12. In one embodiment, the top plate 12 is substantially parallel to the bottom plate 11. The bottom plate 11 comprises a guiding surface 14 for product. In one embodiment, the guiding surface 14 is slanted.

Each transporting device 20 comprises a bottom panel 21, a top panel 23, two side panels 25, and a separating panel 26 located between the two side panels 25. In one embodiment, the top panel 23 is substantially parallel to the bottom panel 21 and perpendicular to the side panels 25. The separating panel 26 is substantially parallel to each side panel 25, so that a first passageway 281 and a second passageway 282 are defined by the separating panel 26 and the two side panels 25. The bottom panel 21 defines an opening 211. A guiding panel 27 extends from a first one of the two side panels 25 and is located above the opening 211. A slot 250 is defined in a second one of the two side panels 25. In one embodiment, the guiding panel 27 is substantially perpendicular to the side panel 25 and parallel to the bottom panel 21. The guiding panel 27 comprises a slanted surface 271 located below the first passageway 281. In one embodiment, a gap 29 is defined between the separating panel 26 and the guiding panel 27, for products extending therethrough. A positioning post 22 protrudes from the top panel 23.

Each driving device 30 is secured to each transporting device 20 and comprises a driving member 31 and a pushing member 32 secured to the driving member 31. The pushing member 32 can be rotated by the driving member 31. In one embodiment, the pushing member 32 is substantially L-shaped.

Each buffering device 40 comprises a hollow box 42 and a supporting panel 41 extending from the hollow box 42. The hollow box 42 comprises opposite first side panels 44 and opposite second side panels 45. In one embodiment, each first side panel 44 is substantially perpendicular to each second side panel 45. The hollow box 42 comprises an entrance 46 and an exit 47 opposite to the entrance 46. In one embodiment, a size of the entrance 46 is substantially equal to a size of the exit 47, and also equal to a size of the opening 211. The supporting panel 43 is substantially perpendicular to the first side panel 44, and a receiving slot 43 is defined in the supporting panel 41.

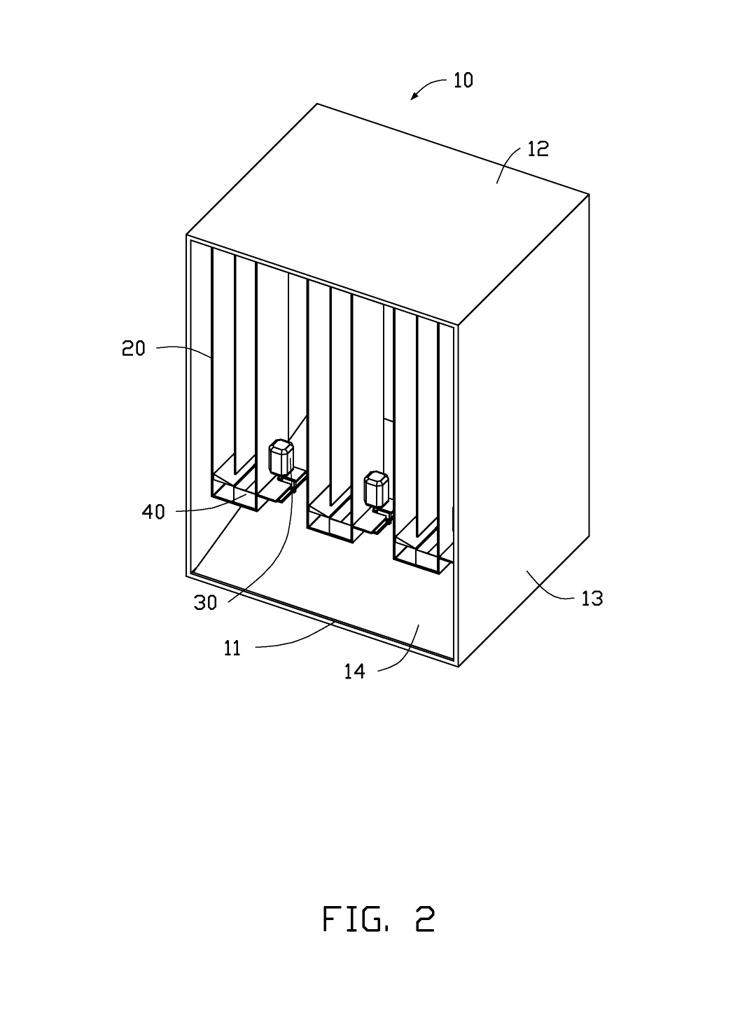

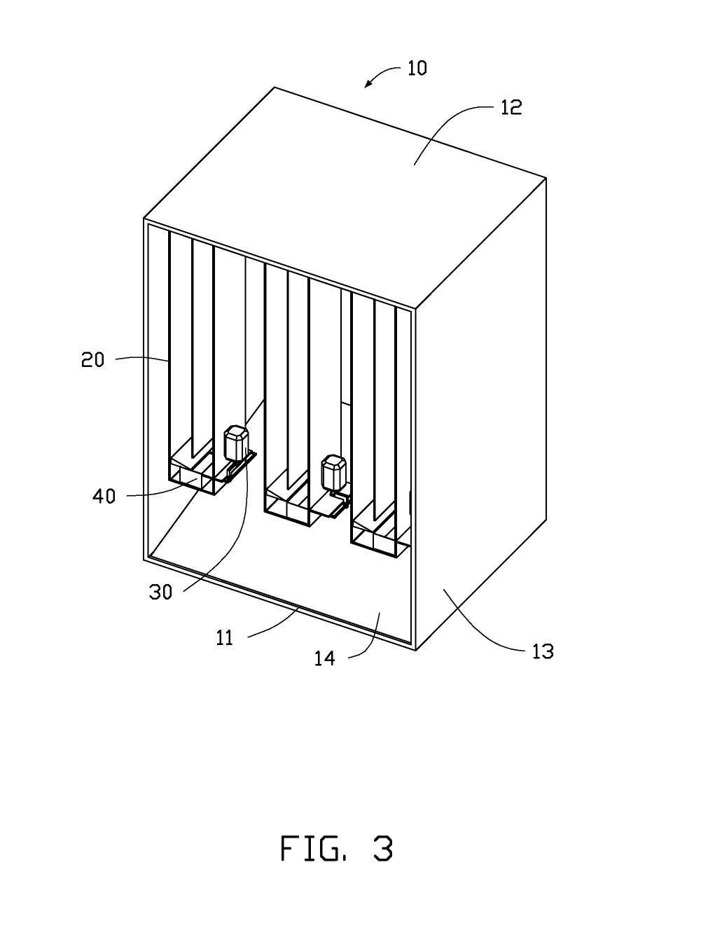

FIGS. 2-3 illustrate assembly of the automatic vending machine in accordance with an embodiment. In assembly, the buffering device 40 is located between the bottom panel 21 and the guiding panel 27, and the supporting panel 41 is aligned with the second one of the two side panels 25. The buffering device 40 is moved towards the second one of the two side panels 25, until the supporting panel 41 extends through the slot 250. The pushing member 32 is received in the receiving slot 43, and the driving member 31 is secured to the cabinet 10 by means, such as screws. At this time, the buffering device 40 is located in a first position (see FIG. 3), the hollow box 42 is located below the first passageway 281, and the entrance 46 is aligned with the first passageway 281. The supporting panel 41 is located on an outside of the side panel 25.

In use, a first product drops into the first passageway 281, extends through the first passageway 281 and drops into the hollow box 42. A second product drops into the second passageway 282, extends through the second passageway 282 and the slanted surface 271, and drops into the hollow box 42. Then, the driving member 30 works and the pushing member 32 is rotated and slid in the receiving slot 43. Thus, the buffering device 40 with the first and second merchandise is moved in a direction that is substantially parallel to the bottom panel 21 by the pushing member 32. Until the exit 47 is aligned with the opening 211, the first and second product moves out of the transporting device 20 via the opening 211. At this time, the buffering device 40 is located in a second position, the hollow box 42 is located below the guiding panel 27, and the supporting panel 41 is located below the first passageway 281 and aligned with the guiding panel 27.

After the first and second products move out of the transporting device 20, the driving member 30 works and the pushing member 32 is rotated and slid in the receiving slot 43 to remove the buffering device 40 back to the first position, to wait for receiving the next product.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a cabinet;
a transporting device secured to the cabinet and comprising a bottom panel and a first passageway located above the bottom panel; the bottom panel defines an opening;
a driving device;
a buffering device movably received in the transporting device; the buffering device engaged with the driving device and comprising a hollow box; the hollow box comprises an entrance and an exit opposite to the entrance;
wherein the buffering device is moveable relative to the bottom panel by the driving device between a first position and a second position; in the first position, the hollow box is located below the first passageway, and the entrance communicates with the first passageway to receive a first product from the first passageway; in the second position, the hollow box is removed from the first passageway, and the exit communicates with the opening to allow the first product out of the bottom panel.

2. The automatic vending machine of claim 1, wherein the buffering device is moveable in a direction that is substantially parallel to the bottom panel.

3. The automatic vending machine of claim 1, wherein the transporting device comprises a first side panel connected to the bottom panel, the buffering device further comprises a supporting panel extending from the hollow box, and the supporting panel extends through the first side panel.

4. The automatic vending machine of claim 3, wherein the first side panel defines a slot, and the supporting panel is moveably received in the slot.

5. The automatic vending machine of claim 3, wherein the supporting panel is substantially parallel to the bottom panel.

6. The automatic vending machine of claim 3, wherein the supporting panel defines a receiving slot, the driving device comprises a pushing member, and the pushing member is rotatable and slidably received in the receiving slot.

7. The automatic vending machine of claim 3, wherein when the buffering device is located in the first position, the supporting panel is located on an outside of the first side panel; and when the buffering device is located in the second position, the supporting panel is located on an inside of the side panel and below the first passageway.

8. The automatic vending machine of claim 3, wherein the transporting device further comprises a second passageway and a guiding panel located below the second passageway, the guiding panel is configured to allow a second product from the second passageway to slide into the hollow box.

9. The automatic vending machine of claim 8, wherein the transporting device further comprises a second side panel, and the guiding panel is substantially perpendicular to the second side panel.

10. The automatic vending machine of claim 9, wherein the transporting device further comprises a separating panel located between the first side panel and the second side panel; the first passageway is defined between the first side panel and the separating panel, and the second passageway is defined between the second side panel and the separating panel.

11. An automatic vending machine comprising:
a cabinet;
a transporting device secured to the cabinet and comprising a bottom panel and a first passageway located above the bottom panel; the bottom panel defines an opening;
a driving device;
a buffering device movably received in the transporting device; the buffering device engaged with the driving device and comprising a hollow box; the hollow box comprises an entrance and an exit opposite to the entrance; the hollow box is located on the bottom panel, and the entrance is aligned with the first passageway, wherein the buffering device is moveable relative to the bottom panel by the driving device in a direction that is substantially parallel to the bottom panel, so that the hollow box is removed from the first passage to align with the opening, for the first product out of the bottom panel.

12. The automatic vending machine of claim 11, wherein the transporting device comprises a first side panel connected to the bottom panel, the buffering device further comprises a supporting panel extending from the hollow box, and the supporting panel extends through the first side panel.

13. The automatic vending machine of claim 12, wherein the first side panel defines a slot, and the supporting panel is moveably received in the slot.

14. The automatic vending machine of claim 12, wherein the supporting panel is substantially parallel to the bottom panel.

15. The automatic vending machine of claim 12, wherein the supporting panel defines a receiving slot, the driving device comprises a pushing member, and the pushing member is rotatable and slidably received in the receiving slot.

16. The automatic vending machine of claim 12, wherein when the buffering device is located in the first position, the supporting panel is located on an outside of the first side panel; and when the buffering device is located in the second position, the supporting panel is located on an inside of the side panel and below the first passageway.

17. The automatic vending machine of claim 12, wherein the transporting device further comprises a second passageway and a guiding panel located below the second passageway, the guiding panel is configured to allow a second product from the second passageway to slide into the hollow box.

18. The automatic vending machine of claim 17, wherein the transporting device further comprises a second side panel, and the guiding panel is substantially perpendicular to the second side panel.

19. The automatic vending machine of claim 18, wherein the transporting device further comprises a separating panel located between the first side panel and the second side panel; the first passageway is defined between the first side panel and the separating panel, and the second passageway is defined between the second side panel and the separating panel.
